(19) United States
(12) Patent Application Publication
(10) Pub. No.: US 2007/0221325 A1
(43) Pub. Date: Sep. 27, 2007

(54) Accelerated B-Stage curing process for thermosetting resins and FBGA assembly process utilizing the accelerated B-Stage curing process

(76) Inventors: Andre Cardoso, Braga (PT); Isabel Macedo, Vila Real (PT); Marta Oliveira, Varzea BCL (PT); Martin Reiss, Dresden (DE)

Correspondence Address: SLATER & MATSIL LLP, 17950 PRESTON ROAD, SUITE 1000, DALLAS, TX, 75252, US

(21) Appl. No.: 11/387,088

(22) Filed: Mar. 22, 2006

(51) Int. Cl. C09J 5/00

(52) U.S. Cl. 156/322

(57) ABSTRACT

An accelerated B-Stage curing process for thermosetting resins and an FBGA assembly process utilizing the accelerated B-Stage curing process in the manufacture of semiconductor devices are disclosed. In an accelerated B-Stage curing process for thermosetting resins, the thermosetting resin is subjected to a heat treatment procedure which is characterized by a predefined treatment temperature and a predefined treatment time, the treatment time comprising a treatment ramp-up time for ramping up resin temperature from current temperature to treatment temperature and a treatment dwell time for holding treatment temperature, the treatment temperature being in the range of over 130 to 190° C., preferably in the range of 150 to 170° C., most preferred in the range of 155 to 165° C. Experience shows that it is beneficial to select the treatment ramp-up time from the range of 1 to 20 min, preferably from the range of 5 to 15 min and most preferred from the range of 6 to 10 min. It is furthermore beneficial to select the treatment dwell time from the range of 15 sec to 12 min and preferably to set treatment dwell time to 1 min.

### TECHNICAL FIELD

The invention relates to an accelerated B-Stage curing process for thermosetting resins and an FBGA assembly process utilizing the accelerated B-Stage curing process in the manufacture of semiconductor devices.

### BACKGROUND

The term “B-Stage” means an intermediate stage in the reaction of a number of thermosetting resins in which the material swells when in contact with certain liquids and softens when heated, but may not entirely dissolve or fuse. Such thermosetting resins are often used as an adhesive, for instance in the manufacture of semiconductor devices.

The resin in an uncured thermosetting molding compound is usually in this stage. The B-Stage curing, or B-Stage, is a thermally induced pre-curing of epoxy-based adhesives specifically used in the chip-apply process. The adhesive is applied in wet form over a substrate where chips are later bonded. B-Stage transforms the adhesive in a deformable state, and enables a repeatable chip-apply process, under controlled force, time and temperature.

The deformation after B-Stage is expected to be repeatable, although B-Stage's high sensitivity to small deviations of time/temperature may cause the adhesive to significantly change its behavior, with large impact on package manufacturability and reliability. In order to improve B-Stage accuracy, process automation is required, but this is only economically viable if the B-Stage is considerably short. By its turn, a shorter B-Stage is only achievable by processing at significantly higher temperatures than that used in state of the art. This invention is based on the development of a shorter B-Stage realized at higher temperatures than those indicated by the supplier, branded Turbo B-Stage, supported by final equivalent adhesive characteristics as from standard B-Stage cycles and by other process advantages over the former process.

### SUMMARY OF THE INVENTION

In an accelerated B-Stage curing process for thermosetting resins, the thermosetting resin is subjected to a heat treatment procedure that is characterized by a predefined treatment temperature and a predefined treatment time, the treatment time comprising a treatment ramp-up time for ramping up resin temperature from current temperature to treatment temperature and a treatment dwell time for holding treatment temperature, wherein the treatment temperature is set at a value significantly higher than prescribed for standard B-Stage curing of any given resin. Specifically, the treatment temperature is set at least 30° C. above the first reaction peak and not bound to the second reaction peak as the upper limit.

Preferably, the treatment temperature, measured in Celsius, is at least 15% higher than the treatment temperature prescribed for standard B-Stage curing. Most preferred, the treatment temperature, measured in Celsius, is at least 25% higher than the treatment temperature prescribed for standard B-Stage curing.

As will be apparent for the skilled person, the percentages given above apply to the Celsius scale only and will be different for other commonly used scales, as for instance the Fahrenheit scale. Therefore, the percentage of increase has to be recalculated depending on the temperature scale used.

As it turns out, it is advisable to elect the treatment temperature from the range of over 130 to 190° C., preferably from the range of 150 to 170° C., most preferred from the range of 155 to 165° C.

When compared to conventional B-Staging, the curing process according to embodiments of the invention can be accomplished in a significantly shorter time, as will be described in more detail hereinafter. This in turn leads to a great reduction of production cost.

Experience shows that it is beneficial to select the treatment ramp-up time from the range of 1 to 20 min, preferably from the range of 5 to 15 min and most preferred from the range of 6 to 10 min.

It is furthermore beneficial to select the treatment dwell time from the range of 15 sec to 12 min and preferably to set treatment dwell time to 1 min.

Furthermore, it is advantageous to ramp up the resin temperature substantially linearly over treatment ramp-up time.

The process described above can be further enhanced by a pre-evaporation step preceding the heat treatment procedure, which is characterized by a predefined pre-evaporation temperature and a predefined pre-evaporation time, the pre-evaporation time comprising a pre-evaporation ramp-up time for ramping up temperature from current temperature to pre-evaporation temperature and a pre-evaporation dwell time for holding pre-evaporation temperature, the pre-evaporation temperature being in the range of 40 to 80° C., preferably in the range of 50 to 70° C., most preferred in the range of 55 to 65° C.

The pre-evaporation ramp-up time may advantageously be selected from the range of 1 to 10 min, preferably from the range of 3 to 8 min and most preferred from the range of 4 to 6 min.

It is furthermore advantageous to select the pre-evaporation dwell time from the range of 1 to 10 min, preferably from the range of 5 to 7 min and most preferred to set the pre-evaporation dwell time to 6 min.

Furthermore, it is advantageous to ramp up the resin temperature substantially linearly over pre-evaporation ramp-up time.

Embodiments of the invention can be carried out combining any of the features disclosed above. It may be expedient to explore what is a suitable combination of features for the process depending on the intended application and the desired result. However, any possible combination of features shall be deemed within the scope of the invention.

The accelerated B-Stage curing process can be utilized with great benefit in an FBGA assembly process comprising the steps of applying a thermosetting resin in wet form over a substrate to form adhesive pads at positions where chips are to be bonded, submitting the thermosetting resin to a B-Stage curing process and finally placing a chip over an adhesive pad and applying pressure to it under controlled temperature, force and time, in order to create an adhesive flow underneath the chip, if the B-Stage curing process is conducted as an accelerated B-Stage curing process as described above. Again, the use of any combination of features disclosed with reference to the accelerated B-Stage curing process in such FBGA assembly process shall be deemed within the scope of the invention.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a schematic drawing of an assembly of a PCB substrate and chips applied to the substrate;

FIG. 2 is a schematic drawing of a bonding channel in a PCB substrate and the points of measurement referred to hereinafter;

FIG. 3 is a DSC analysis chart showing two reaction peaks during curing of the thermosetting resin;

FIG. 4 is an example chart for a temperature profile of the accelerated B-Stage curing according to the invention;

FIG. 5 is a comparative depiction of the deformation behavior of the resin cured according to the invention and of the resin cured according to the prior art approach;

FIG. 6 shows the normalized deformation level variance for nine runs of pre-cure temperature and time optimization;

FIG. 7 shows DSC analysis results for samples of three adhesive batches cured high and low-temperature pre-cure cycles; and

FIG. 8 shows DSC peak areas variability (2^{nd} peak) for the Standard and Turbo B-Stage cycles.

### DETAILED DESCRIPTION OF ILLUSTRATIVE EMBODIMENTS

Embodiments of this invention refer to the execution of B-Stage curing at temperatures higher than that of the state of the art-here labeled as “Standard B-Stage” and performed in the 120˜130° C. range. Specifically, in a preferred embodiment, the B-Stage process is performed in the range of 130° C. to 190° C. This innovative shorter B-Stage was branded “Turbo B-Stage”. In order to demonstrate the equivalence between Turbo and Standard B-Stage, the adhesive deformation level under identical chip-apply conditions were compared, as well as the results from DSC analysis.

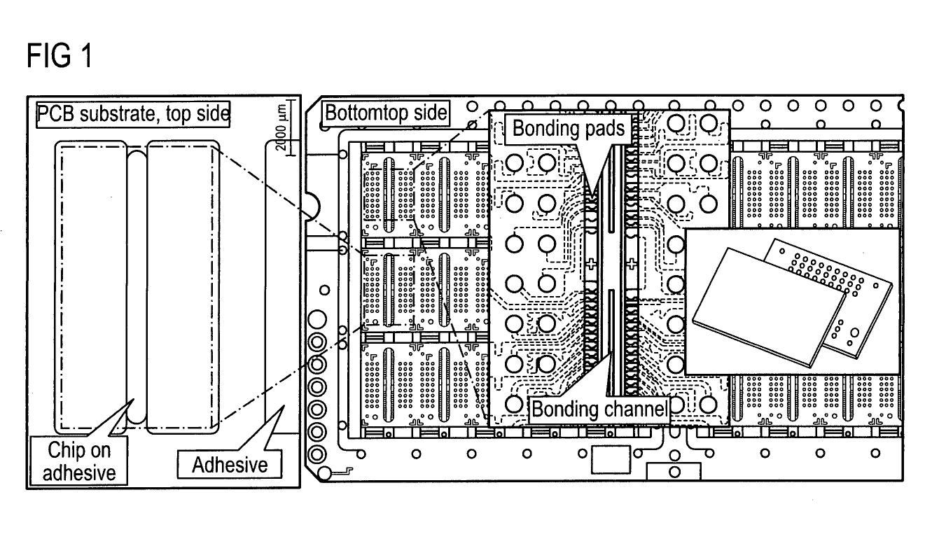

In modem memory chip FBGA assembly technology (Fine-pitch Ball Grid Array), the chip is applied over a very thin circuit board, which acts as a support substrate and contains all electrical connections to the outside. In FIG. 1, such an assembly of a PCB substrate with chips applied to it is shown. The electrical connections to the chip are made through a narrow slot in the substrate, called bonding channel. The chip is fixed to the substrate by a thermal-deformable adhesive. The adhesive is first deposited over the substrate in wet form by stencil printing to form adhesive pads at the position where the chips are later bonded. The adhesive is then submitted to a thermally induced pre-cure, called B-Stage, for initial mechanical rigidity and viscosity. In the chip-apply process, the chip is placed over the adhesive and compressed under controlled temperature, force and time, in order to create an adhesive flow underneath the chip.

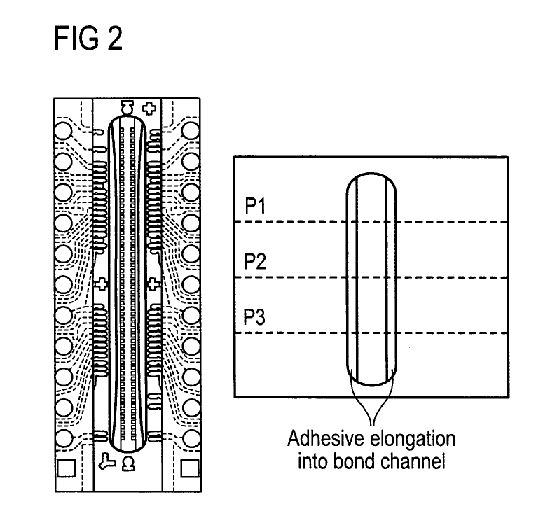

Besides thermal compression parameters, the level of adhesive deformation is also a function of adhesive viscosity after B-Stage, which is expected to be constant and predictable. The process result can be visually checked and controlled by the amount of adhesive that elongates into the bonding channel during the die attach process. This is a critical process step, because both insufficient and excessive deformation of the adhesive have a strong negative impact on the chip assembly and package reliability see, F. N. Sinnadurai, Handbook of Microelectronics Packaging and Interconnection Technologies, Electrochemical Publications Limited, Scotland (1985), and Eugene R. Hnatek, Integrated Circuit Quality and Reliability. Marcel Dekker Inc, New York (1995), both of which are incorporated herein by reference. FIG. 2 is a schematic drawing of such bonding channel in a PCB substrate and the points of measurement of the adhesive deformation.

However, the B-Staging is quite sensitive to temperature and time, as small deviations change the adhesive behavior significantly, with consequent impact on the chip-apply process.

DSC, as used herein, refers to Differential Scanning Calorimetry, a thermoanalytical technique in which the difference in the amount of heat required to increase the temperature of a sample and reference are measured as a function of temperature. Both the sample and reference are maintained at very nearly the same temperature throughout the experiment. Generally, the temperature program for a DSC analysis is designed such that the sample holder temperature increases linearly as a function of time. The reference sample should have a well-defined heat capacity over the range of temperatures to be scanned. The basic principle underlying this technique is that, when the sample undergoes a physical transformation such as phase transitions, more (or less) heat will need to flow to it than the reference to maintain both at the same temperature. By observing the difference in heat flow between the sample and reference, differential scanning calorimeters are able to measure the amount of energy absorbed or released during such transitions. DSC is widely used in industrial settings as a quality control instrument due to its applicability for studying polymer curing.

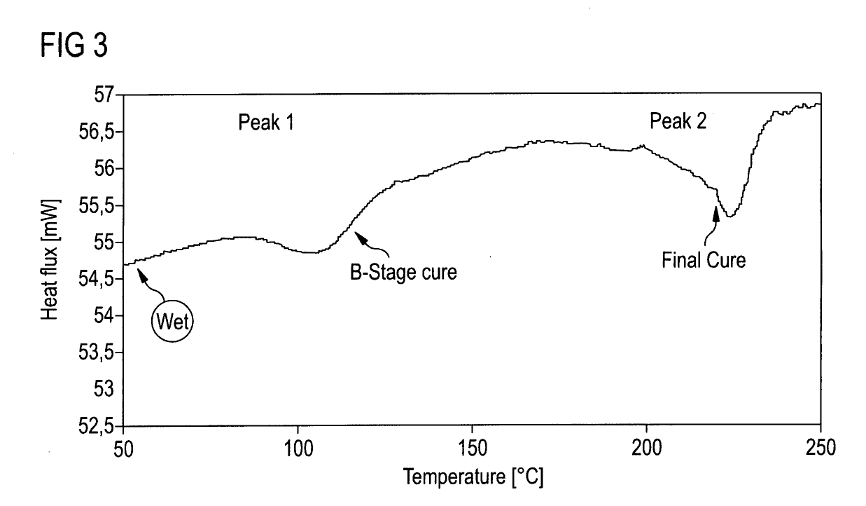

FIG. 3 shows a DSC analysis on a ‘B-Stageable’ adhesive, clearly showing two reaction peaks. B-Stage, taking place at 120˜130° C., is responsible for completing the first reaction, transforming the adhesive into a state with the desired rheologic properties for the chip-apply process. In fact, the B-Stage time/temperature conditions should ensure a specific high adhesive viscosity, which in turn, and under controlled thermal compression conditions, would lead to a required laminar flow during chip apply. Hence, the chip-apply process is very sensitive to B-Stage. After the chip-apply step, the final cure at high temperatures completes the second reaction, for fully curing the adhesive and for mechanical rigidity.

In the state-of-the-art, B-Staging is accomplished by submitting the adhesive at temperatures in the range of 100 to 130° C. during a time range of 60 to 120 min, depending on the particular adhesive supplier. Typically, B-staging is done at 125° C. during 90 min. This is done typically in batch ovens, with manual loading and unloading, requiring extensive human intervention, therefore, prone to human errors and time inaccuracy. Moreover, the large process time (e.g., 90 min) requires a large battery of ovens for volume production, which in turn magnifies the effect of oven-to-oven variation. The combination of time and temperature inaccuracy and oven-to-oven variation often results in non-suitable variability of the adhesive deformation behavior, beyond the chip-apply process window. For this reason the B-Stage tolerance was set quite narrow (as low as +/−2 min, +/−2° C.), in order to keep deformation within acceptable variation limits, but such narrow tolerances are not compatible with manual processes performed in a large number of equipments.

Automation reduces human factor and provides time accuracy, but for long processes and for volume production, automation implies either very large equipment and/or a large number of automatic ovens. Off-the-shelf tools such as reflow ovens would provide automation but are not practical solutions for the 90 min typical process: for example, a belt running at 50 mm/min (very low speed) would result in a hot section of 4.5 m and would carry 75 substrates (the substrate is ˜60 mm in its shortest dimension). For an average-sized production plant, this corresponds to 5˜10% of total production, dictating the need for more than 10 ovens, at least 7 m long (considering loading, cooling and unloading zones). Furthermore, solutions based on the reflow oven concept carry a high risk of losses, because any overflow at the output or any mechanical malfunctioning would cause the substrates to stop at the hot section and to be exposed to heat longer than desired. All substrates with over-cured adhesive must then be discarded. Other existing solutions based on batch ovens are also bothered by large process times, because investment and footprint are prohibitively high and might not have return.

Thus, in order to allow automation, it is important to have very short B-Stage cycles. This further minimizes the number of B-Stage ovens required, limiting the effects of oven-to-oven variation. Above all, it is crucial to ensure the equivalence of adhesive deformation behavior between shorter and standard B-Stage cycles at the chip-apply process. On the other hand small differences between adhesive batches may also be responsible for the variability on deformation. Nevertheless, the new shorter B-Stage must not amplify those differences.

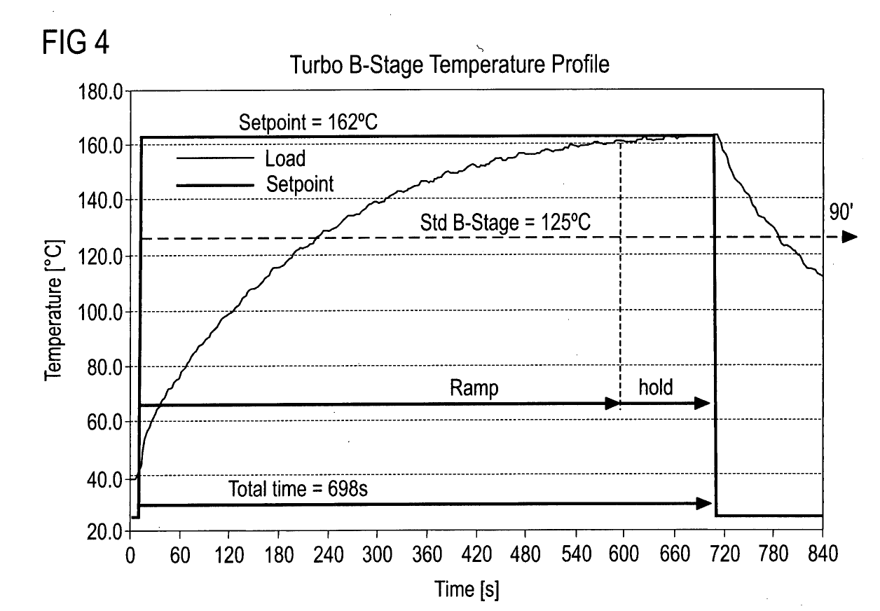

FIG. 4 shows an example of the temperature profile of a B-Stage cycle performed at 162° C., reducing the time to 10˜12 min, in comparison to the typical 90 min of the state of the art (at 125° C.). Most of the profile is spent on ramping-up, suggesting that a faster ramp could yield to an even shorter B-Stage cycle. Note that although the work here presented refers to B-Stage performed in the range of 160˜165° C., it is not intended to limit the concept of Turbo B-Stage to this range.

On adhesive-printed substrates processed with both Turbo and Standard B-Stage cycles, chips of uniform dimensions were applied, using the same chip-apply equipment (Alphasem SL-9022HSL) and applying constant thermo-mechanical compression parameters.

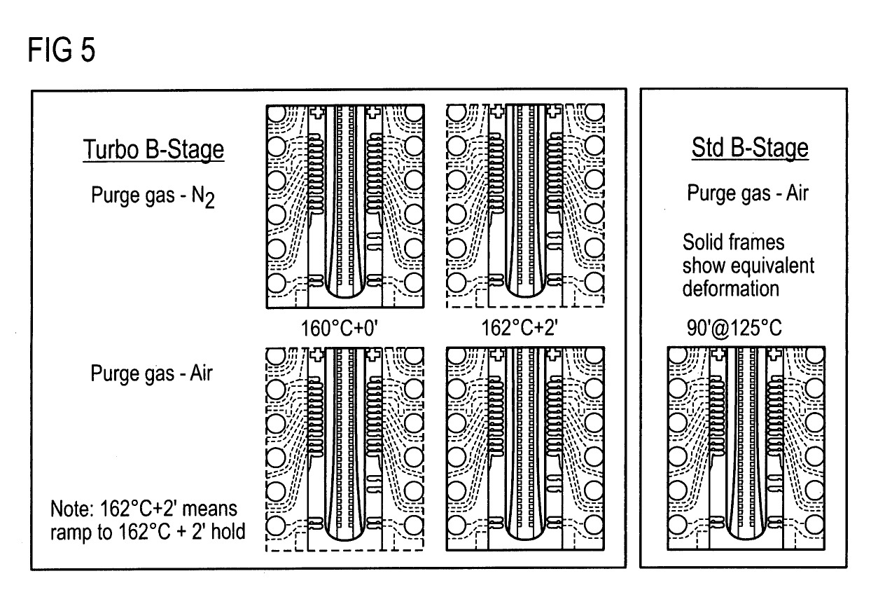

FIG. 5 shows the adhesive elongation into the bonding channel, using both Turbo and Standard B-Stage, the former cycle tested both nitrogen and air atmosphere during the cure. The deformation equivalence is clearly visible, but while Standard B-Stage took 90 min, Turbo B-Stage took only 10˜12 min (compare FIG. 4). It is also noted, that for the same deformation level, the Turbo B-Stage cycle in nitrogen atmosphere is reduced. That the nitrogen atmosphere can act as a boosting factor was already known for the Standard B-Stage and as shown, it is supporting equivalent curing mechanism within both cycles.

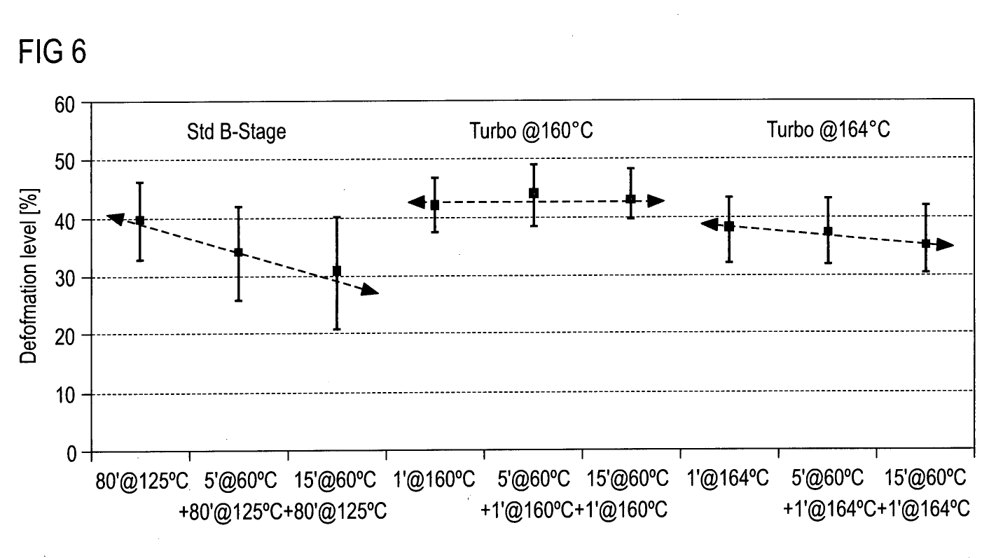

Besides the deformation equivalence, the impact of batch-to-batch variation and a pre-evaporation step at 60° C. were also evaluated, for both Turbo and Standard B-Stage cycles. Results of this evaluation are shown in FIG. 6. According to the adhesive supplier, no reaction is expected to occur at temperatures <60° C., so the pre-evaporation step only induces degassing of solvents, present in the wet adhesive. Pre-evaporation is expected to simulate the inherent adhesive degassing at room temperature, during the waiting time between wet adhesive application and B-Staging, which also affects process stability.

The adhesive elongation induced by thermo-mechanical compression was optically measured and registered in terms of bonding channel width fulfillment (%, see FIG. 2). Measurements were done at defined chip positions (P1, P2 and P3; FIG. 2), on two chips per run, using an optical microscope (Leica VMM-200, 10×).

The batch-to-batch variability is presented as vertical bars for each process condition. A total of five adhesive batches were used. Non-vertical dotted lines indicate the average trend of deformation for increasing pre-evaporation condition (0′, 5′@60° C. and 15′@60° C.).

All runs with no pre-evaporation conditioning showed a similar deformation level, confirming the mechanical equivalence of the different B-Stage cycles. In comparison to the Standard B-Stage, a slight reduction of the batch-to-batch variability was observed for the Turbo B-Stage, particularly at 160° C. This indicates that the Turbo B-Stage has a positive or at least no negative impact on the process stability due to adhesive variation. The increase of pre-evaporation causes a reduction of the adhesive elongation when using the Standard B-Stage, revealing a higher sensitivity to the waiting time between adhesive application and B-Staging. Conversely, the deformation behavior at Turbo B-Stage seems to be independent of the pre-evaporation. In a production environment, this is a significant benefit of the Turbo B-Stage, because process robustness is enhanced due to the low sensitivity to process flow delays. Furthermore, this low sensitivity to a pre-evaporation step potentially allows the Turbo B-Stage cycle to be further shortened, as pre-heating can occur in parallel to B-Staging in an automatic pipeline oven, reducing the time that the B-Stage cycle takes for temperature ramp-up.

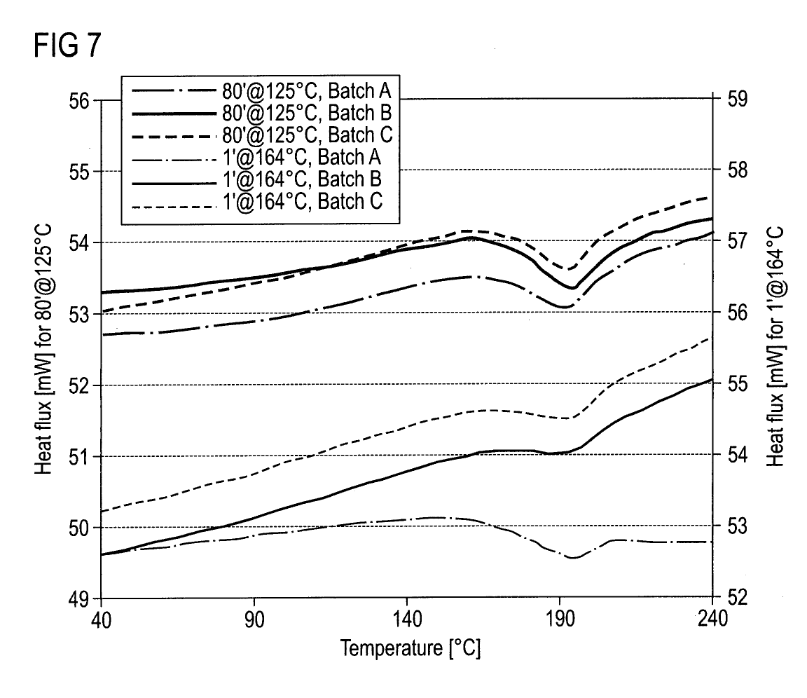

In parallel, the DSC analysis (Perkin Elmer DSC 7, 10° C./min in CDA) was performed on selected 125° C. and 164° C. B-Staged samples, in order to evaluate the equivalence of B-Stage curing intensity. The results of this analysis are shown in FIG. 7. Both groups of curves are showing only the second reaction peak, when compared to FIG. 3. The equivalence between the reactivity of Turbo and Standard B-Stage cycles is supported by the similar DSC curves obtained and especially by the total absence of the first reaction peak. Thus, similar adhesive deformation performance during the chip-apply process can be expected for both cycles.

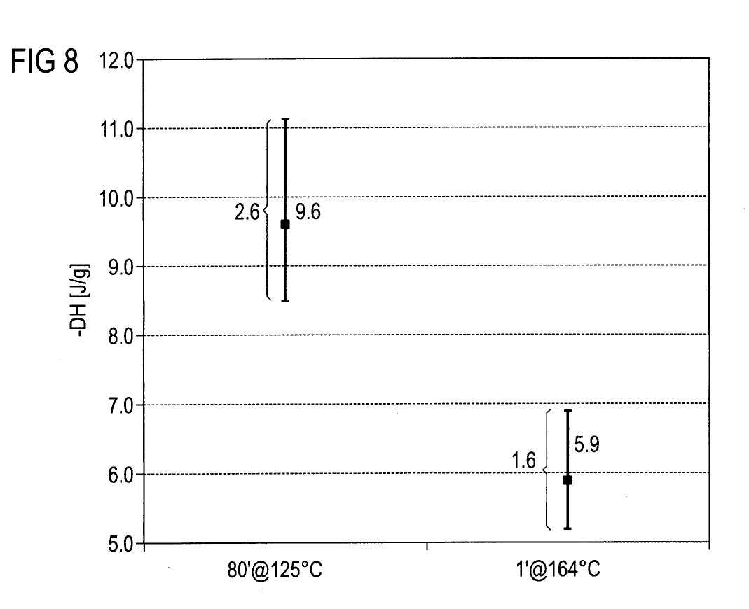

FIG. 8 measures and compares the DSC peak areas of the second peak. Although a smaller peak area was observed for the Turbo B-Stage, the variance of the peak areas is smaller than that for Standard B-Stage. This suggests that the reaction intensity during the B-Stage is more stable for samples B-Staged at 164° C., which is in agreement with the more constant deformation level observed for these samples (vertical bars FIG. 6).

Aiming process automation enabled by a short B-Stage cycle, and ensuring robust chip-apply process, the following could be concluded and claimed about the innovative Turbo B-Stage:

Turbo B-Stage reduces the process cycle time in comparison to Standard B-Stage, while the resulting deformation behavior on B-Stageable adhesives is equivalent in both processes. This is a crucial factor for B-Stage automation.

Deformation behavior of adhesives processed with Turbo B-Stage cycles is independent of waiting time between wet adhesive application and B-Stage curing cycle, contrarily to those processed with Standard B-Stage. This is a production benefit, because process robustness is enhanced due to the low sensitivity to process flow delays.

The low sensitivity of Turbo B-Staging to a pre-evaporation step at 60° C. allows the pre-heating of the substrates with adhesive, which further shortens the Turbo B-Stage cycle by reducing temperature ramp time.

Turbo B-Stage reduces the effect of the adhesive batch-to-batch variability on the deformation behavior, in comparison to the Standard B-Stage. This is also a production benefit, and represents a further enhancement of the process robustness due to lower insensitivity to material deviations.

What is claimed is:

1. An accelerated B-Stage curing process for thermosetting resins wherein the thermosetting resin is subjected to a heat treatment procedure which is characterized by a treatment temperature and a treatment time, the treatment time comprising a treatment ramp-up time for ramping up resin temperature from a current temperature to the treatment temperature and a treatment dwell time for holding the treatment temperature, wherein the treatment temperature is set at a value greater than 130° C.

2. The process of claim 1 wherein the treatment temperature is in the range of over 130 to 190° C.

3. The process of claim 2, wherein the treatment temperature is in the range of 150 to 170° C.

4. The process of claim 3, wherein the treatment temperature is in the range of 155 to 165° C.

5. The process of claim 1, wherein treatment ramp-up time is in the range of 1 to 20 min, preferably in the range of 5 to 15 min.

6. The process of claim 5, wherein the treatment temperature is in the range of 6 to 10 min.

7. The process of claim 6, wherein the treatment dwell time is in the range of 15 sec to 12 min.

8. The process of claim 1, wherein the treatment dwell time is in the range of 15 sec to 12 min.

9. The process of claim 1, wherein the resin temperature is ramped up substantially linearly over treatment ramp-up time.

10. The process of claim 1, wherein the heat treatment procedure is preceded by a pre-evaporation step which is characterized by a pre-evaporation temperature and a pre-evporation time, the pre-evaporation time comprising a pre-evaporation ramp-up time for ramping up temperature from a current temperature to the pre-evaporation temperature and a pre-evaporation dwell time for holding the pre-evaporation temperature, the pre-evaporation temperature is in the range of 40 to 80° C.

11. The process of claim 10, wherein the pre-evaporation temperature is in the range of 55 to 65° C.

12. The process of claim 10, wherein the pre-evaporation ramp-up time is in the range of 3 to 8 min.

13. The process of claim 10, wherein the pre-evaporation ramp-up time is in the range of 4 to 6 min.

14. The process of claim 12, wherein the pre-evaporation dwell time is in the range of 5 to 7 min.

15. The process of claim 11, wherein the pre-evaporation dwell time is in the range of 5 to 7 min.

16. The process of claim 10, wherein the resin temperature is ramped up substantially linearly over the pre-evaporation ramp-up time.

17. An accelerated B-Stage curing process for thermosetting resins wherein the thermosetting resin is subjected to a heat treatment procedure which is characterized by a treatment temperature and a treatment time, the treatment time comprising a treatment ramp-up time for ramping up resin temperature from current temperature to treatment temperature and a treatment dwell time for holding treatment temperature, wherein the treatment temperature is set at a value significantly higher than prescribed for standard B-Stage curing.

18. The process of claim 17, wherein the treatment temperature is set at least 30° C. above the first reaction peak and not bound to the second reaction peak as the upper limit.

19. The process of claim 18, wherein the treatment temperature, measured in Celsius, is at least 15% higher than the treatment temperature prescribed for Standard B-Stage curing.

20. The process of claim 19, wherein the treatment temperature, measured in Celsius, is at least 25% higher than the treatment temperature prescribed for Standard B-Stage curing.

21. A method of making an FBGA assembly, the method comprising:
applying a thermosetting resin in wet form over a substrate to form adhesive pads at positions where chips are to be bonded;
submitting the thermosetting resin to a B-Stage curing process that includes ramping up a temperature from a current temperature to a treatment temperature during a ramp up time and then holding the temperature at the treatment temperature for a treatment dwell time, wherein the treatment temperature is greater than 130° C., the ramp up time is between 1 min and 20 min and the treatment dwell time is between 15 sec and 12 min; and
placing a chip over an adhesive pad and applying pressure to it under controlled temperature, force and time, in order to create an adhesive flow underneath the chip.

22. The process of claim 21 wherein the treatment temperature is in the range of over 130 to 190° C.

23. The process of claim 22, wherein the treatment temperature is in the range of 150 to 170° C.

24. The process of claim 21, wherein the treatment temperature is in the range of 6 to 10 min.

25. The process of claim 21, wherein the resin temperature is ramped up substantially linearly over treatment ramp-up time.
